(19) United States
(12) Patent Application Publication
(10) Pub. No.: US 2005/0177526 A1
(43) Pub. Date: Aug. 11, 2005

(54) Method for negotiations using a global pricing system

(75) Inventors: Grace Shung Shin Lin, Palo Alto, CA (US); Ping Heng Lin, Hsin-Chu (TW); Sajiv Dalal, San Jose, CA (US); Wan-Chen Tsao, Yangmei Town (TW); Rick Cassidy, San Jose, CA (US); Ming Ta Hsu, Hsin-Chu (TW); Jeffrey Bunce, Campbell, CA (US)

Correspondence Address: HAYNES AND BOONE, LLP, 901 MAIN STREET, SUITE 3100, DALLAS, TX, 75202, US

(73) Assignee: Taiwan Semiconductor Manufacturing Co., Ltd., Hsin-Chu (TW)

(21) Appl. No.: 10/774,521

(22) Filed: Feb. 9, 2004

(51) Int. Cl. G06F 17/00

(52) U.S. Cl. 705/400

(57) ABSTRACT

A method for improving negotiations using a global pricing system includes retrieving customer information from a database and retrieving negotiation information from a database. The customer information and negotiation information are stored on a mobile device. The information is used to generate a negotiation range, and negotiations are conducted using the negotiation range and the information on the mobile device. Results of the negotiation are stored on the mobile device to be transmitted to a database. If a pricing decision has to be made based on the negotiation results, a case document is built based on customer information and account sales information. The case document is then provided to a case analyzer, along with internal information. The case analyzer is then used to generate a case summary document. The case summary document is used to make a pricing decision, and a database is adjusted to reflect the decision.

### BACKGROUND

This disclosure relates generally to semiconductor manufacturing and more particularly to a method for improving negotiations using a global pricing system.

As sophisticated businesses become global, problems arise in relation to making pricing decisions for the complex products and services that these businesses offer. Pricing unity across regions, customers, and market segments is desirable, but dynamic markets are constantly changing the variables that go into making a pricing decision. Furthermore, these pricing decisions must be relayed to negotiators who negotiate with different customers, each customer with different needs whose price quote can depend on many different factors.

Conventional pricing systems have used price books created manually by gathering data in disparate systems with limited availability. If a price adjustment needed to be made from the price set out in the price book, a manual process is initiated to compile data in order for management to process the adjustment. These systems suffer many shortfalls, including inconsistent input and output data, processes that consume time, arbitrary price setting and adjustments, and conflicts among regions and customers.

In addition, negotiations with a customer have suffered from these conventional pricing systems. Negotiators have used these hard copy price books that are generated with extensive manual work to develop a negotiation framework that suffers from many shortfalls, including a data organization and retrieval process that are very time consuming and error prone due to data being partially stored in multiple places, time delays and potential omissions between data updates and negotiations, confidentiality issues related to having hard copy price books, and having limited access to data.

Accordingly, it would be desirable to provide a method for improving negotiations using a global pricing system absent the disadvantages found in the prior methods discussed above.

### BRIEF DESCRIPTION OF THE DRAWINGS

FIG. 1 is a flow diagram illustrating a mobile device retrieving information from a regional database;

FIG. 2 is a flow diagram illustrating a mobile device retrieving information from a central database;

FIG. 3 is a flow diagram illustrating the types of information that are retrieved from a regional database;

FIG. 4 is a flow diagram illustrating the types of information that are retrieved from a central database;

FIG. 5 is a flow diagram illustrating a negotiation using the mobile device;

FIG. 6 is a flow diagram illustrating a mobile device transmitting to a regional database;

FIG. 7 is a flow diagram illustrating a mobile device transmitting to a central database;

FIG. 8 is a flow diagram illustrating a pricing decision;

FIG. 9 is a flow diagram illustrating customer information being added to a case document;

FIG. 10 is a flow diagram illustrating account sales information being added to a case document;

FIG. 11 is a flow diagram illustrating regional information being added to a case document;

FIG. 12 is a flow diagram illustrating a case document and internal information being entered into a case analyzer in order to output a case summary.

### DESCRIPTION

It is to be understood that the following disclosure provides many different embodiments, or examples, for implementing different features of the disclosure. Specific examples of components and arrangements are described below to simplify the present disclosure. These are, of course, merely examples and ate not intended to be limiting. In addition, the present disclosure may repeat reference numerals and/or letters in the various examples. This repetition is for the purpose of simplicity and clarity and does not in itself dictate a relationship between the various embodiments and/or configurations discussed.

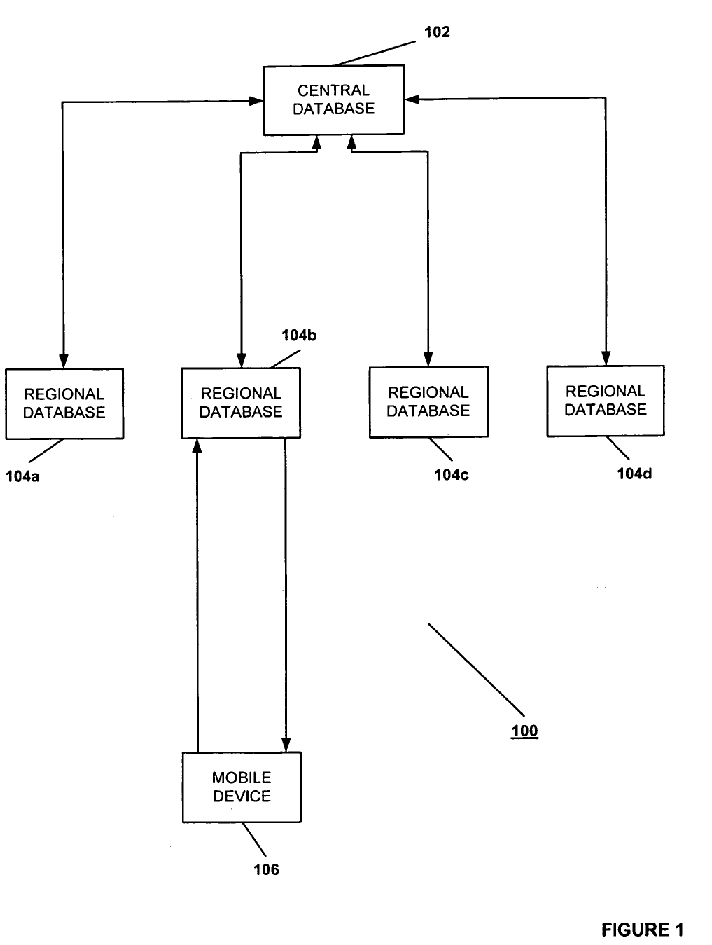

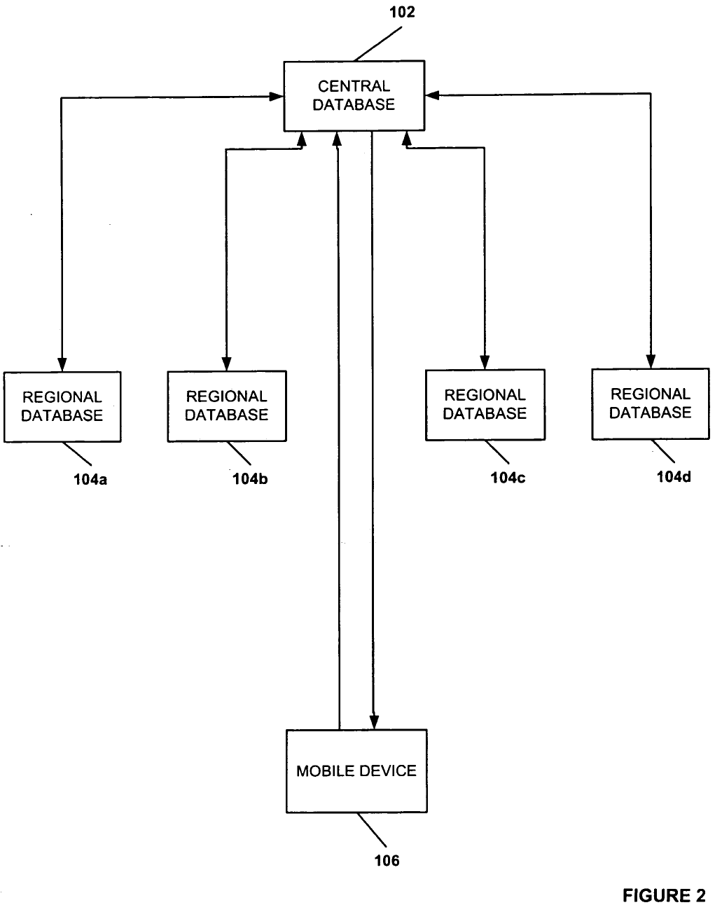

In one embodiment, a global pricing and negotiation system 100, FIG. 1, includes a central database 102 that is connected to a plurality of regional databases 104a, b, c, and d. Central database 102 includes information such as updated product and service price information, customer account specific information, and product or services price quote histories. Centralized database 102 is periodically synchronized with the plurality of regional databases 104 so that global information stored in centralized database 102 is updated with the regional information and regional databases 104 are updated with global information from central database 102. A mobile device 106 can be used to retrieve information from and transmit information to one or more of regional database 104a-d. Alternatively, mobile device 106, FIG. 2, can retrieve information from and transmit information to centralized database 102. The mobile device 106 will generally be used by a negotiator from a given region in order facilitate negotiation with a customer in that region, but retrieval from the centralized database 102 may be necessary when information is not available on a given regional database 104. Examples of the mobile device 106 include a portable computer, PDA device, or cellular phone.

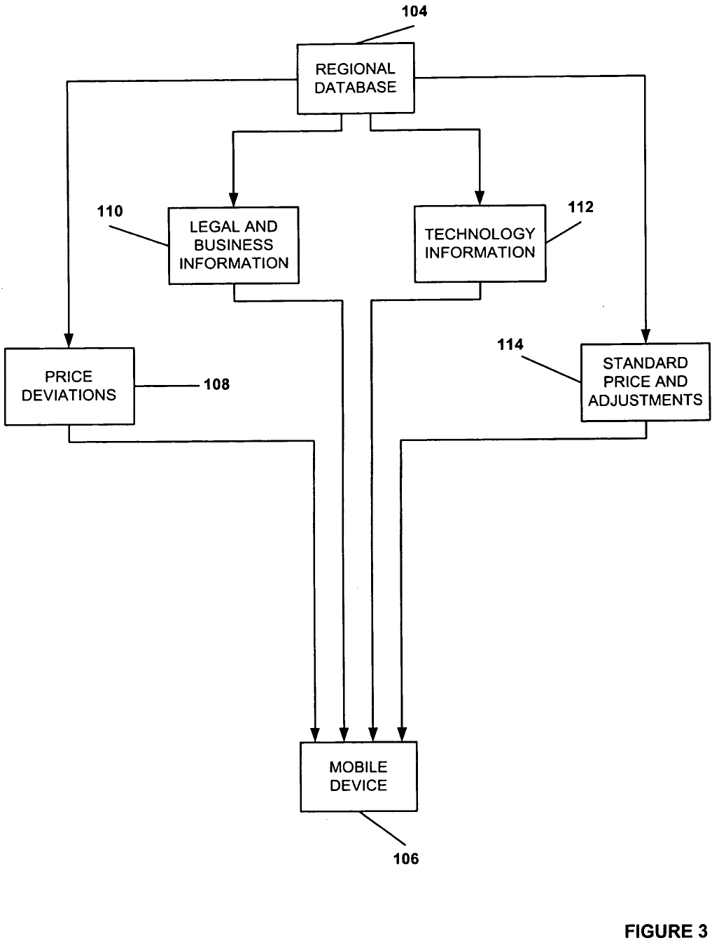

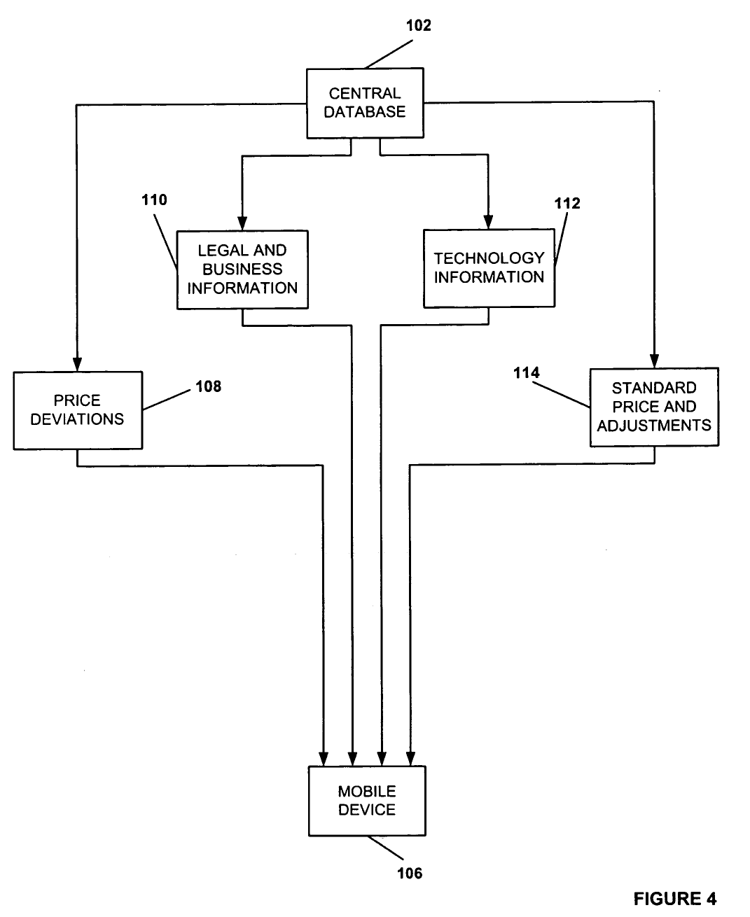

In retrieving information from centralized database 102 and/or regional databases 104, FIGS. 3 and 4, mobile device 106 will collect and store information such as price deviation information 108, legal and business information 110, technology information 112, and standard price and adjustment information 114. Price deviation information 108 includes information such as a history of deviations from a standard price for a product, or a history of price deviations for a specific customer. Legal and business information 110 includes information such as customer specific business and legal terms relevant to the negotiation. Technology information 112 includes information such as product or service information relevant to the negotiation. Standard price and adjustment information 114 includes information such as a list price for the product or service to be negotiated, list discounts, and previously negotiated or approved customer specific prices. Retrieval and storage of the information can occur close in time to a desired negotiation to allow the periodic synchronization between centralized database 102 and regional databases 104 to make the information retrieved as accurate as possible.

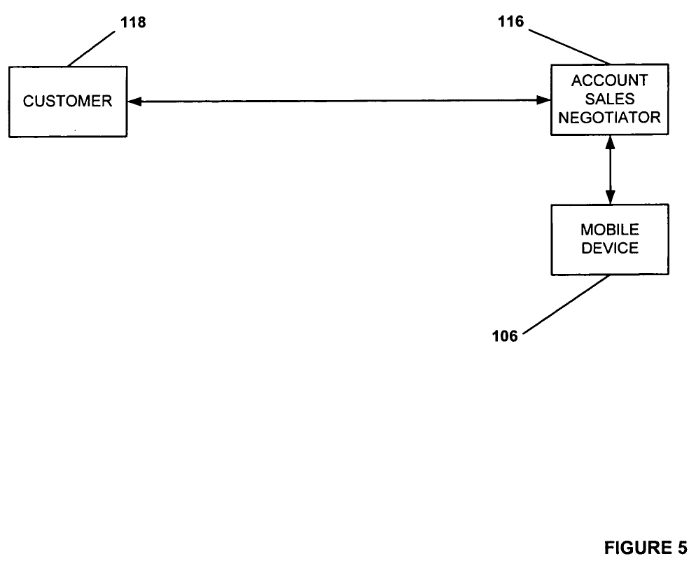

Once retrieval and storage to mobile device 106 has occurred, an account sales negotiator 116, FIG. 5, can go negotiate with a customer 118 using mobile device 106. Mobile device 106 can use the stored information to generate price quotations within pre-approved limits and allowable deviations from those quotations for the negotiation. Due to the periodic synchronization between centralized database 102 and regional databases 104, negotiation with mobile device 106 and the information contained on it can be accomplished without upsetting global pricing across regions, across technologies/services, across market segments, and across customers. Results of the negotiation can be recorded on mobile device 106.

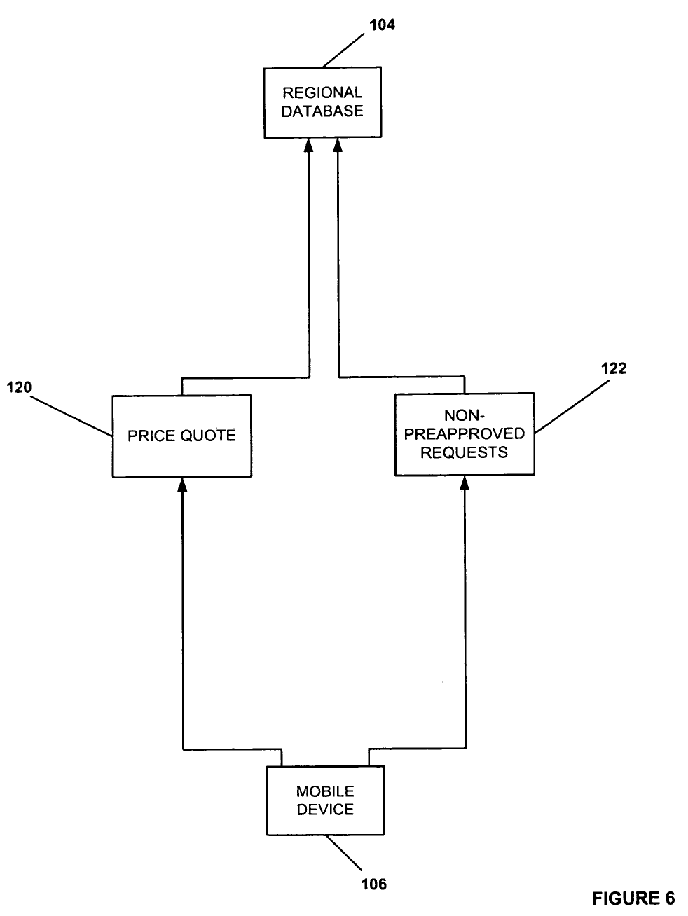

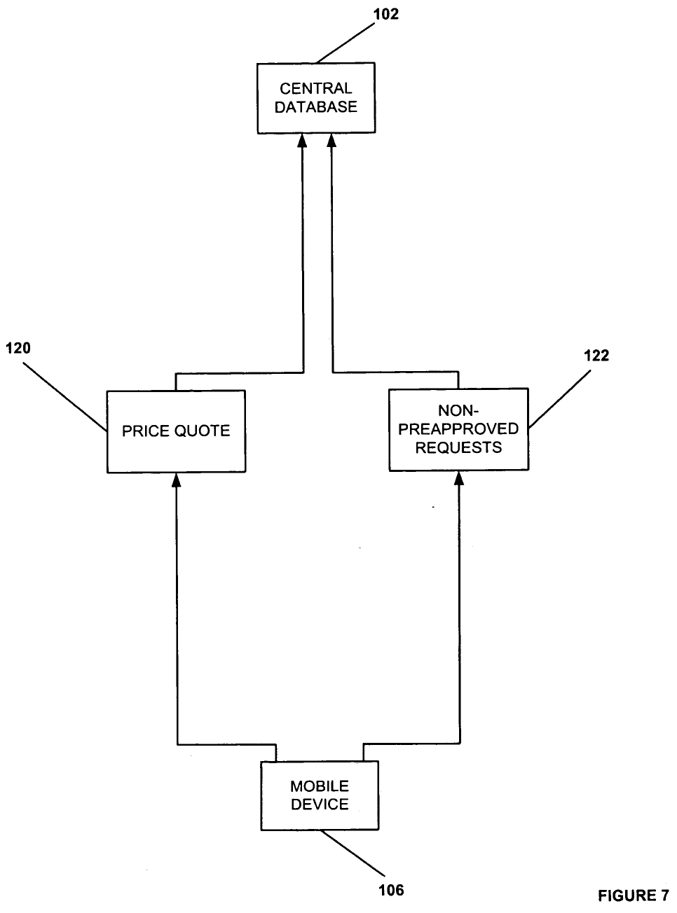

When a negotiation is finished, mobile device 106, FIGS. 6 and 7, is used to transmit the results of the negotiation to either regional database 104 or centralized database 102. Transmitted information includes information such as price quote information 120 and non-approved requests information 122. Price quote information 120 includes information such as the price quoted for the product or service negotiated and the deviation within the range generated by mobile device 106 from the information retrieved. Non-approved requests information 122 includes information such as a price quotes outside the allowable deviation range. When non-approved requests information 122 is transmitted, such information is marked for review.

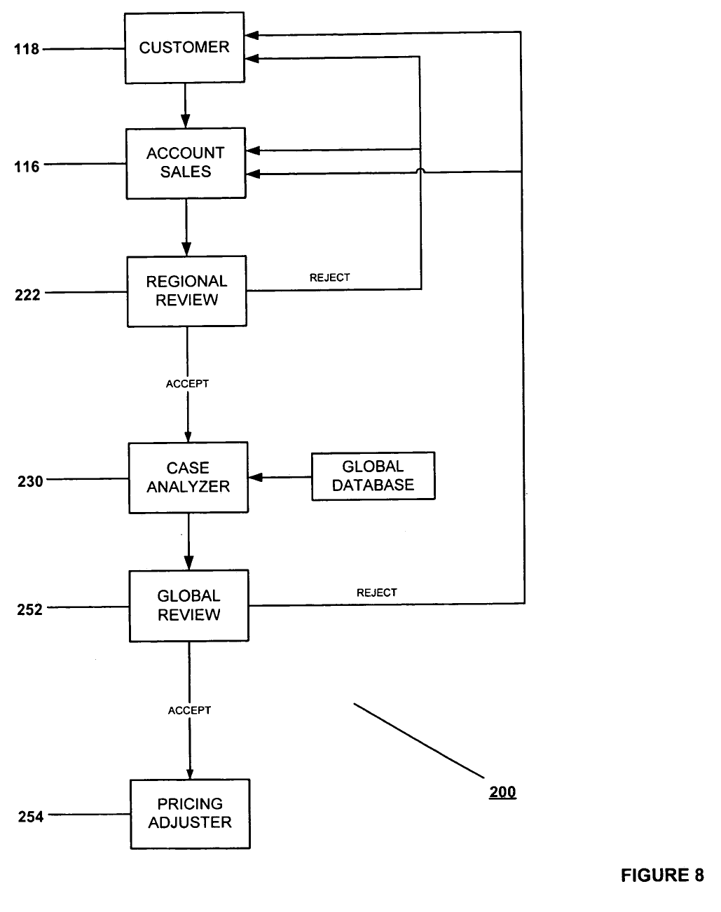

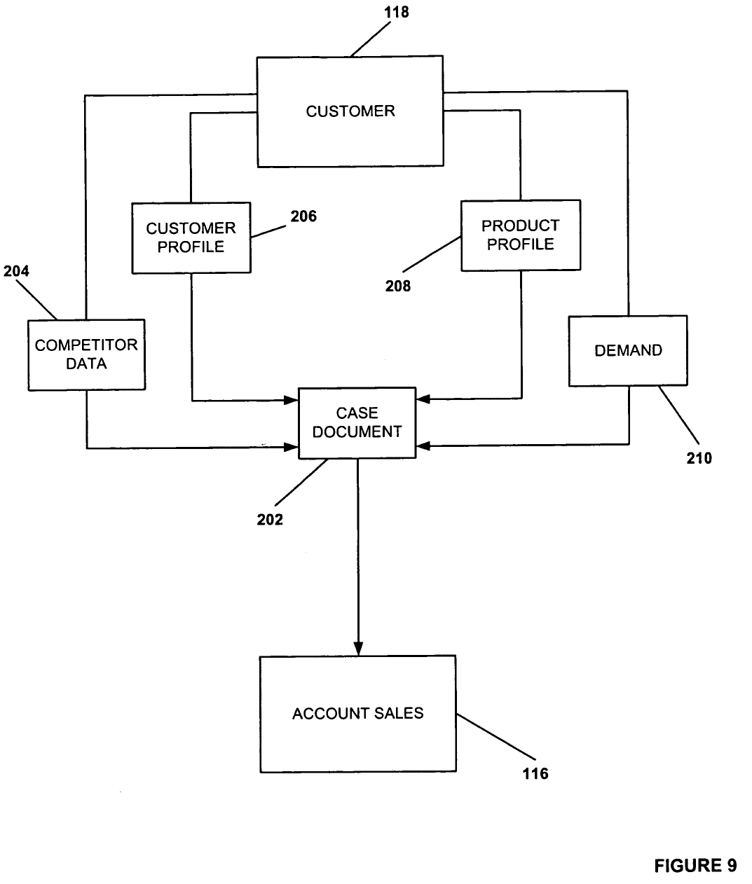

When non-approved requests information 122 is marked for review, pricing decision system 200, FIG. 8, is used. Pricing decision system 200 works by generating a case document 202, FIG. 9-12 to which information is added throughout pricing decision system 200. During negotiation, FIGS. 8 and 9, information from customer 118 is added to the case document 202. This information includes competitor data information 204, customer profile information 206, product profile 208, and demand information 210. Competitor data information 204 includes information such as the price offered to customer 118 by other sellers. Customer profile information 206 includes information such as the size of customer 118. Product profile information 208 includes information such as the type of product or service for which a price adjustment is being requested. Demand information 210 includes information such as how much of the product or service is going to be needed and when it will be needed.

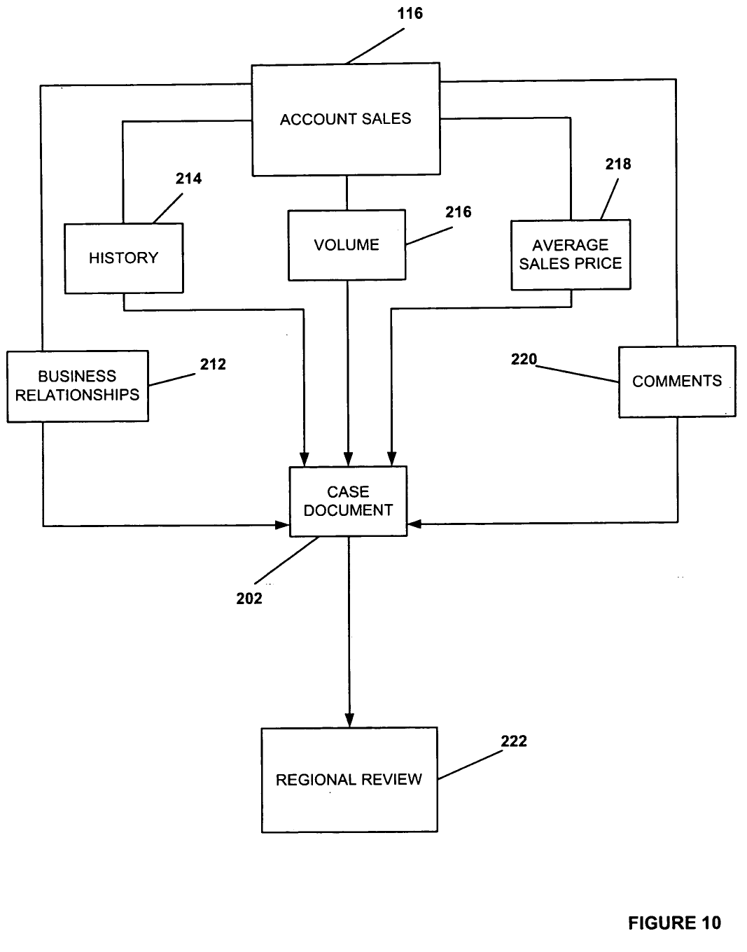

Once customer 118 furnishes information needed to start case document 202, account sales 116, FIGS. 8 and 10, then adds information to case document 202. This information includes business relationships information 212, history information 214, volume information 216, average sales price information 218, and comment information 220. Business relationship information 212 includes information such as the type of relationship carried on with customer 118 and the strategy for customer 118 in the future.. History information 214 includes information such as previous negotiations for other products and services with customer 118. Volume information 216 includes information such as the amount of products or services that the region can provide. Average sales price information 218 includes information such as the average price received for a product or service over a period of time. Comment information 220 includes information such as account sales 116 additional reasons for why a price adjustment should be made. Once customer 118 and account sales 116 have added their information to case document 202, case document 202 is submitted to regional review 222.

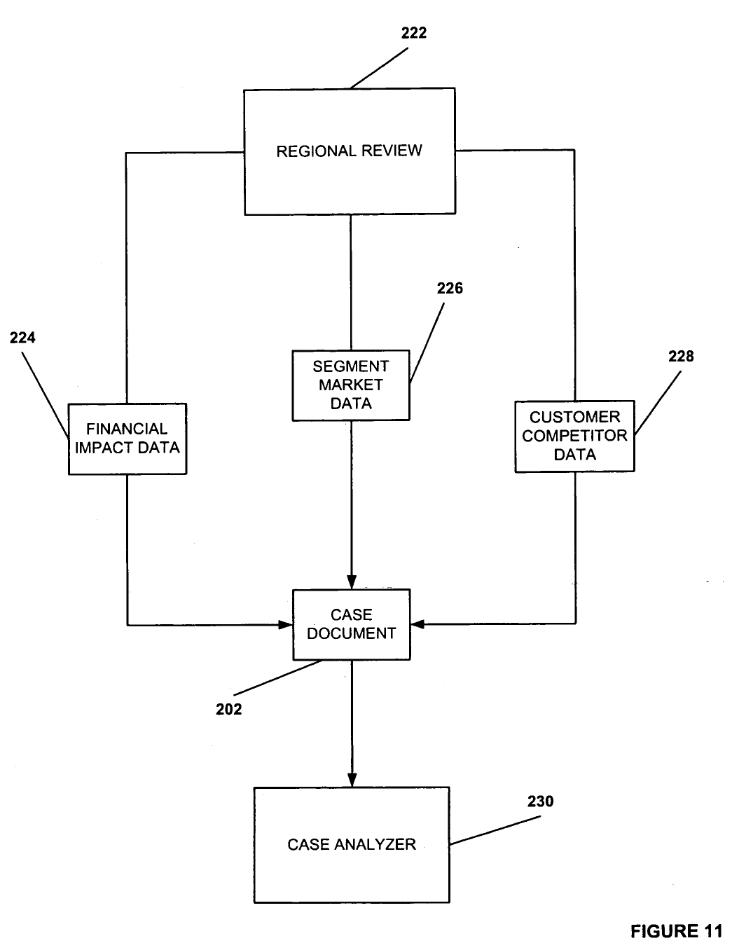

When regional review 222 receives case document 202, FIG. 8, they may either accept case document 202 or reject it. If case document 202 is rejected, regional review 222 sends the reasons for rejection back to account sales 116 and customer 118. If regional review 222 accepts case document 202, FIGS. 8 and 11, regional review 222 adds additional information to case document 202. This information includes financial impact data information 224, segment market data information 226, and customer competitor data information 228. Financial impact data information 224 includes information such as the financial impact accepting the pricing adjustment will have on the region. Segment market data information 226 includes information such as how accepting the pricing adjustment will effect the segment market for this product or service. Customer competition data information 228 includes information such as how the competitors of customer 118 will be affected in the pricing adjustment is accepted. Case document 202 then proceeds to a case analyzer 230.

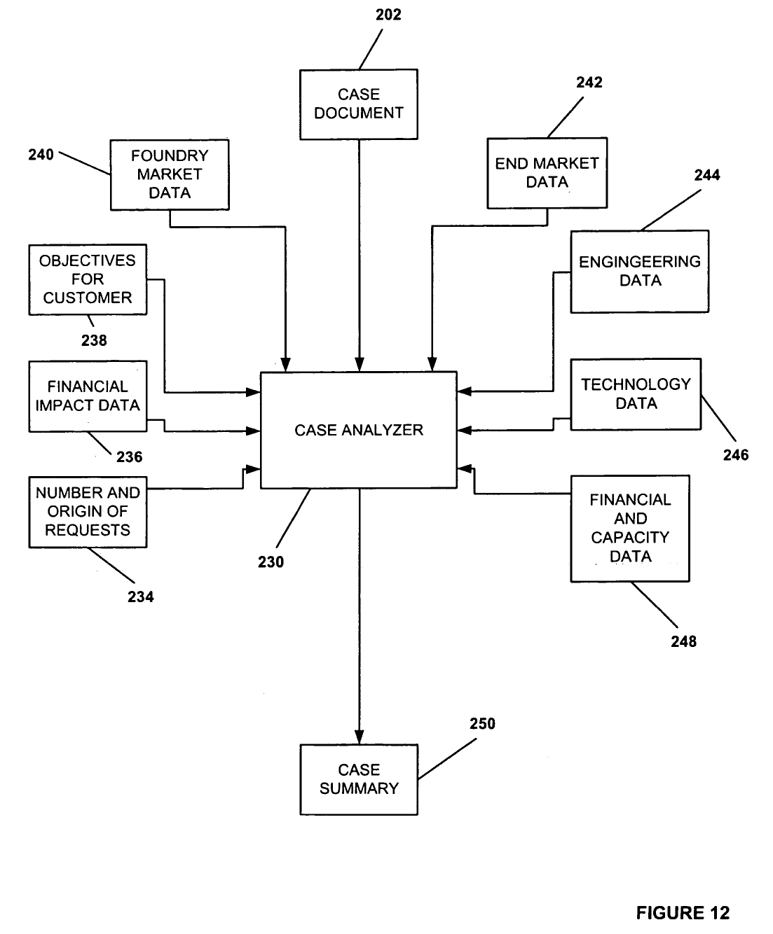

Case analyzer 230 receives case document 202, FIGS. 8 and 12, and then receives information from a global database 232. Information from global database 232 includes number and origin of requests information 234, financial impact data information 236, objectives for customer information 238, foundry market data information 240, end market data information 242, engineering data information 244, technology data information 246, and financial and capacity data 248. Number and origin of requests information 234 includes information such as the global quantity of requests for this product and which regions the request are from. Financial impact data information 236 includes information such as the global financial effect that accepting a pricing adjustment will have. Objectives for customer information 238 include information such as what is wanted from customer 118 and whether this pricing adjustment is meant to be an attempt to buy market share. Foundry market data information includes information such as what is happening in the foundry market, who is supplying silicon to the competition of customer 118, what the price is for the particular technology in the market, and what new competitors are in the market. End market data information 242 includes information such as what is happening in the end market, what end markets the customer 118 serves, who the competition of customer 118 is, and what the competitive position of customer 118 is. Engineering data information 244 includes information such as what manufacturing capacity and yield is for a product or service. Technology data information 246 includes information such as whether the technology is new, mature, or old technology. Financial and capacity data 248 includes information such as what impact accepting the pricing adjustment will have financially and with capacity allocation. Case analyzer 230 takes case document 202 and information from global database 232 and generates a case summary 250.

Case summary 250 is generated by using information from case document 202 and global database 232 in complex formulas. For example, a wafer buy price can be determined by the equation [Wafer Price=Wafer Cost*1/(1−X %)] where X is set depending on the family of technology or market segment the product or service is from. Wafer cost is impacted by how well-utilized manufacturing equipment is, as higher utilization results in a lower cost per wafer. Information from the case document will provide utilization information, along with how the customer demand will effect this utilization number. As can be seen, this wafer cost will be a snapshot in time as orders from other customers will continuously change this value. As an additional example, a die buy price can be set by the equation [Die Price=Wafer Price/((Gross Die/Wafer)*Yield))]. Wafer price would be affected by the Wafer Price equation, along with information from the case document and the global database concerning yield estimations, technology complexity, and the number of mask layers.

Case summary 252 will include additional information: Pricing options with technology, market segment, and revenue and profit impact analysis. A value equation to support the generated price options for customer communication, the value equation including the value brought to customer 118, and how this value can justify a possible price premium, the speed and performance advantages the technology brings, the cost savings the technology provides, and benefits of accepting this pricing options over competitors. Case summary 252 will also enable comparisons between customers in similar market segments, customers using similar technologies, and customers in different geographic sales regions.

Once case summary 250 is generated, it is sent for global review 252. Global review 252 receives case summary 250 and may either accept or reject it. If case summary 252 is rejected, the reasons for rejection are sent back to account sales 116 and customer 118. If case summary 252 is accepted, it is sent to pricing adjuster 254. Pricing adjuster 254 will update the price for the product or service for customer 118 in centralized database 102.

Although only a few exemplary embodiments of this disclosure have been described in detail above, those skilled in the art will readily appreciate that many modifications are possible in the exemplary embodiments without materially departing from the novel teachings and advantages of this disclosure. Accordingly, all such modifications are intended to be included within the scope of this disclosure as defined in the following claims.

1. A method for processing a semiconductor industry pricing decision comprising:
building a case document based on customer information and account sales information;
providing the case document to a case analyzer;
providing internal information to the case analyzer; and
generating a case summary document by the case analyzer.

2. The method of claim 1 further comprising:
making a pricing decision using the case summary document.

3. The method of claim 2 further comprising:
adjusting a database based on the pricing decision.

4. The method of claim 2 further comprising:
adjusting a product price within a range based on the pricing decision.

5. The method of claim 2 wherein the pricing decision is provided to the customer and the account sales.

6. The method of claim 1 wherein the customer information includes a quantity of a product that is needed and a date when the product is needed.

7. The method of claim 1 wherein the account sales information includes a history of price quotes offered to the customer.

8. The method of claim 1 further comprising:
reviewing the case document before providing it to the case analyzer to make a decision whether to provide the case document to the case analyzer.

9. The method of claim 8 wherein the decision is made to provide the case document to the case analyzer whereby regional information is added to the case document before the case document is provided to the case analyzer.

10. The method of claim 9 wherein the regional information includes data on the financial impact of the pricing decision.

11. The method of claim 8 wherein the decision is made not to provide the case document to the case analyzer and that decision is provided to the customer and the account sales.

12. The method of claim 1 wherein the internal information provided to the case analyzer includes market data.

13. A method for processing a semiconductor industry pricing decision comprising:
receiving customer order information;
providing account sales information that is specific to the customer order information; building a case document based on the customer order information and the account sales information;
providing the case document to a case analyzer program;
providing internal information to the case analyzer program; and
generating a case summary document by the case analyzer program.

14. The method of claim 13 further comprising:
making a pricing decision using the case summary document.

15. The method of claim 14 further comprising:
adjusting a database based on the pricing decision.

16. The method of claim 14 further comprising:
adjusting a product price within a range based on the pricing decision.

17. The method of claim 14 wherein the pricing decision is provided to the customer and the account sales.

18. The method of claim 13 wherein the customer order information includes a quantity of a product that is needed and a date when the product is needed.

19. The method of claim 13 wherein the account sales information includes a history of price quotes offered to the customer.

20. The method of claim 13 further comprising:
reviewing the case document before providing it to the case analyzer program to make a decision whether to provide the case document to the case analyzer program.

21. The method of claim 20 wherein the decision is made to provide the case document to the case analyzer program whereby regional information is added to the case document before the case document is provided to the case analyzer.

22. The method of claim 21 wherein the regional information includes data on the financial impact of the pricing decision.

23. The method of claim 20 wherein the decision is made to not provide the case document to the case analyzer program and that decision is provided to the customer and the account sales.

24. The method of claim 13 wherein the internal information provided to the case analyzer program includes market data.

25. A method for negotiating with a customer in the semiconductor industry comprising:
retrieving customer information from a database;
retrieving negotiation information from a database;
storing the customer information and the negotiation information on a mobile device;
generating a negotiation range based on the customer information and the negotiation information;
negotiating with a customer using the negotiation range and the information stored on the mobile device;
recording negotiation results obtained during negotiations on the mobile device; and
transmitting the negotiation results to a database.

26. The method of claim 25 wherein the customer information includes previously approved price deviations from a standard price for products or services supplied to the customer.

27. The method of claim 25 wherein the negotiation information includes technology information relating to a product or service to be negotiated with a customer.

28. The method of claim 25 wherein the databases are regional and are periodically updated from a centralized database.

29. The method of claim 25 wherein the database that the customer information and the negotiation information are retrieved from is a centralized database.

30. The method of claim 25 wherein the negotiation results are marked for review if they are not within a predetermined approved range.

31. The method of claim 25 further comprising:
updating the databases based on information obtained from the negotiation results.

32. A method for negotiating with a customer in the semiconductor industry comprising:
retrieving from a database previously approved price deviations from a standard price for products or services supplied to a customer;
retrieving negotiation information from a database;
storing the price deviation information and the negotiation information on a mobile device;
generating a negotiation range based on the customer information and negotiation information;
negotiating with a customer using the negotiation range and the information stored on the mobile device;
recording negotiation results obtained during negotiations on the mobile device; and
transmitting the negotiation results to a database.

33. The method of claim 32 wherein the negotiation information includes legal and business information specific to the customer.

34. The method of claim 32 wherein the negotiation information includes a standard price and pricing adjustments relating to a product or service to be negotiated with a customer.

35. The method of claim 32 wherein the databases are regional and are periodically updated from a centralized database.

36. The method of claim 32 wherein the database that the price deviation information and the negotiation information are retrieved from is a centralized database.

37. The method of claim 32 wherein the negotiation results are marked for review if they are not within a predetermined approved range.

38. The method of claim 32 wherein the mobile device generates the negotiation range.

39. The method of claim 32 further comprising:
updating the databases based on information obtained from the negotiation results.

40. A method for negotiating with a customer in the semiconductor industry comprising:
retrieving from a database previously approved price deviations from a standard price for products or services previously supplied to a customer;
retrieving from a database legal and business information specific to the customer;
retrieving from a database a standard price and pricing adjustments relating to a product or service to be negotiated with a customer;
retrieving technology information relating to a product or service to be negotiated with a customer;
storing the retrieved information on a mobile device;
generating a negotiation range based on the information stored on the mobile device;
negotiating with a customer using the negotiation range and the information stored on the mobile device;
recording negotiation results obtained during negotiations on the mobile device; and
transmitting the negotiation results to a database.

41. The method of claim 40 wherein the databases are regional and are periodically updated from a centralized database.

42. The method of claim 40 wherein the databases that information is retrieved from is a centralized database.

43. The method of claim 40 wherein the negotiation results are marked for review if they are not within a predetermined approved range.

44. The method of claim 40 wherein the mobile device generates the negotiation range.

45. The method of claim 40 further comprising:
updating the databases based on information obtained from the negotiation results.
